(19) United States
(12) Patent Application Publication
(10) Pub. No.: US 2019/0257153 A1
(43) Pub. Date: Aug. 22, 2019

(54) SYSTEM AND METHOD FOR MITIGATING TORSIONAL VIBRATIONS

(71) Applicant: Nabors Drilling Technologies USA, Inc., Houston, TX (US)

(72) Inventors: Amir Badkoubeh, Calgary (CA); Mohammad Vakil, Calgary (CA)

(21) Appl. No.: 15/899,281

(22) Filed: Feb. 19, 2018

(51) Int. Cl. E21B 3/035; E21B 44/04; E21B 43/12; G05D 19/02; G05B 19/402

(52) U.S. Cl. CPC E21B 3/035; E21B 44/04; G05B 19/056; G05D 19/02; G05B 19/402; E21B 43/126

(57) ABSTRACT

A method of rotating a drill string driven by a drive system using a control system implemented by a controller or a filter includes generating a mathematical energy model of the drive system, the drill string, and the controller, wherein the mathematical energy model comprises at least one or more first energy values of the drive system and one or more second energy values of the drill string, determining the one or more first energy values of the drive system and the one or more second energy values of the drill string, measuring one or more vibration values torsional vibrations at the drive system with a sensor, determining an updated proportional gain and an updated integral gain of the controller or the filter based on at least the one or more first energy values of the drive system, the one or more second energy values of the drill string, and the one or more vibration values, providing an output signal representing the updated proportional gain and the updated integral gain to the controller or the filter, and controlling rotation of a quill of the drive system based on the output signal.

### BACKGROUND

Embodiments of the present disclosure relate generally to the field of drilling and processing of wells. More particularly, the present embodiments relate to a system and method for addressing torsional vibrations (e.g., stick-slip oscillations) during drilling operations.

In conventional oil and gas operations, a well is typically drilled to a desired depth with a drill string, which may include drill pipe or drill collar and a drill bit. The drill pipe may include multiple sections of tubular that are coupled to one another by threaded connections or tool joints. During a drilling process, the drill string may be supported and hoisted about a drilling rig and be lowered into a well. A drive system (e.g., a top drive) at the surface may rotate the drill string to facilitate drilling a borehole. Because the drill string is a slender structure relative to the length of the borehole, the drill string is subject to various vibrations or oscillations due to the interaction of the drill string with the borehole wall, as well as input from the drive system.

Stick-slip oscillations may be severe, self-sustained and periodic torque fluctuations of the drill string torque. Stick-slip may be generally defined as the torsional vibration of downhole components or equipment (e.g., drill pipe, drill bit). Due to frictional losses between the drill bit and the edges of the borehole, the drill bit may rotate non-uniformly and may even stop periodically for a few seconds. During this time, the drill string may continue to rotate at a constant speed and thus, the drill string may wind up and store energy which may act as a torsional spring. When the drill bit starts spinning again, the drill string will unwind, the stored energy may suddenly be released, and the torque may drop. The drive system (e.g., top drive) may be controlled such that it may mitigate these torsional vibrations in the drill string. Torsional vibrations (e.g., stick-slip oscillations) are recognized as being a source of issues, such as premature bit wear, equipment degradation, over-torqued connections, and a reduced rate of penetration.

### BRIEF DESCRIPTION

In accordance with one aspect of the disclosure, a method of rotating a drill string driven by a drive system using a control system implemented by a controller or a filter includes generating a mathematical energy model of the drive system, the drill string, and the controller, wherein the mathematical energy model comprises at least one or more first energy values of the drive system and one or more second energy values of the drill string, determining the one or more first energy values of the drive system and the one or more second energy values of the drill string, measuring one or more vibration values torsional vibrations at the drive system with a sensor, determining an updated proportional gain and an updated integral gain of the controller or the filter based on at least the one or more first energy values of the drive system, the one or more second energy values of the drill string, and the one or more vibration values, providing an output signal representing the updated proportional gain and the updated integral gain to the controller or the filter, and controlling rotation of a quill of the drive system based on the output signal.

In accordance with another aspect of the disclosure, a system for rotating a drill string includes a drive system configured to rotate the drill string at variable rotational speeds based on control signals received by the drive system, and a control system configured to transmit the control signals to the drive system, wherein the control system is configured to generate the control signals based on at least a mathematical energy model of the drive system, the drill string, and the control system, and one or more vibration values of torsional vibrations at the drive system, wherein the mathematical energy model comprises at least one or more energy values of the drive system.

In accordance with another aspect of the disclosure, a control system includes an automation controller including a processor and a memory configured to supply a drive system for rotating a drill string with control signals based on a mathematical energy model of at least the drive system and the drill string, and one or more vibration values of torsional vibrations at the drive system, wherein the mathematical energy model comprises at least one or more first energy values of the drive system and one or more second energy values of the drill string, and a display visualization configured to display at least the one or more vibration values of the torsional vibrations and a torque value of the drive system.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic diagram of an embodiment of a drilling rig including a drilling control system, in accordance with present techniques;

FIG. 2 is a schematic diagram of an embodiment of a closed-loop hydraulic circuit of a hydraulic top drive, in accordance with present techniques;

FIG. 3 is a schematic diagram of an embodiment of a mechanical representation of the hydraulic top drive of FIG. 2 and the drill string of FIG. 1, in accordance with present techniques;

FIG. 4 is a schematic diagram of an embodiment of a mechanical representation of an electric top drive and the drill string of FIG. 1, in accordance with present techniques;

FIG. 5 is a schematic diagram of an embodiment of a drilling control system of FIG. 1, in accordance with present techniques;

FIG. 6 is a method for mitigating torsional vibrations, in accordance with present techniques; and

FIG. 7 is user interface for displaying a status of torsional vibrations in accordance with present techniques.

### DETAILED DESCRIPTION

As discussed above, the frictional engagement of the drill string and/or drill bit of the drilling rig with the borehole or formation may cause the drill string to stick and slip. For example, due to the interaction with the formation, the drill bit may slow down and finally stall while the drive system is still in motion. This may cause the drill bit to be suddenly released after a certain time and to start rotating at a very high speed. The velocity oscillations of the drill bit may give rise to the emission of torsional waves from the lower end of the drill string. The wave may travel up along the drill string and may reflect from the drive system.

With the foregoing in mind, the disclosed embodiments provide techniques for mitigating or reducing the torsional vibrations (e.g., slip-stick) of the drill string during drilling operations. Specifically, a drilling control system may be provided including a speed controller (e.g., proportional-integral (PI) controller) or a high pass filter for controlling the speed of the drive system. The drilling control system may be designed for the drive system to mitigate torsional vibrations by calculating proper gains (e.g., proportional and integral gains) or selecting a proper filter using an energy method and a Fast Fourier analysis to fit the model to the downhole dynamics. The speed controller may then adjust the speed of rotation of the drive system to reduce or mitigate the torsional vibrations. Additionally, the drilling control system may calculate a suggested weight-on-bit value based on a coefficient of friction (e.g., bit aggressiveness) of the drill bit and characteristics of the formation into which the borehole is drilled to avoid reappearance of the torsional vibrations during the drilling operations. It should be understood that the present embodiments are discussed mainly within the context of a hydraulic drive systems (e.g., hydraulic top drives), however they are also applicable to electric drive systems (e.g., electric top drives) or other types of top drive systems.

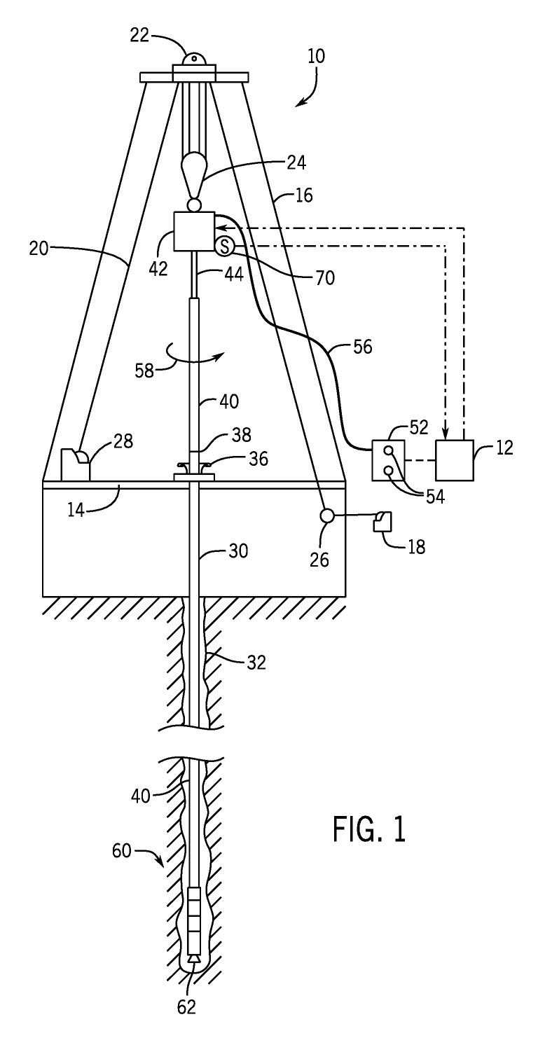

Turning now to the drawings and referring first to FIG. 1, a schematic diagram of a drilling rig 10 including a drilling control system 12 in accordance with the present disclosure is illustrated. The drilling rig 10 may feature an elevated rig floor 14 and a derrick 16 extending above the rig floor 14. A supply reel 18 may supply drilling line 20 to a crown block 22 and traveling block 24 that may be configured to hoist various types of drilling equipment above the rig floor 14. The drilling line 20 may be secured to a deadline tiedown anchor 26, and a drawworks 28 may regulate the amount of drilling line 20 in use and, consequently, the height of the traveling block 24 at a given moment. Below the rig floor 14, a drill string 30 may extend downward into a wellbore 32 and may be held stationary with respect to the rig floor 14 by slips 36. The drill string 30 may include multiple sections of threaded tubular 40 that are threadably coupled together. It should be noted that present embodiments may be utilized with drill pipe, casing, or other types of tubular.

A portion of the drill string 30 may extend above the rig floor 14 and may be coupled to a top drive 42 (e.g., hydraulic top drive or electric top drive). The top drive 42, hoisted by the traveling block 24, may engage and position the drill string 30 (e.g., a section of the tubular 40) above the wellbore 32. Specifically, the top drive 42 may include a quill 44 used to turn the tubular 40 and, consequently, the drill string 30 for drilling operations. After setting or landing the drill string 30 in place such that the male threads of one section (e.g., one or more joints) of the tubular 40 and the female threads of another section of the tubular 40 are engaged, the two sections of the tubular 40 may be joined by rotating one section relative to the other section (e.g., in a clockwise direction) such that the threaded portions tighten together. Thus, the two sections of tubular 40 may be threadably joined. During other phases of operation of the drilling rig 10, the top drive 42 may be utilized to disconnect and remove sections of the tubular 40 from the drill string 30. As the drill string 30 is removed from the wellbore 32, the removed sections of the tubular 40 may be detached by disengaging the corresponding male and female threads of the respective sections of the tubular 40 via rotation of one section relative to the other in a direction opposite that used for coupling.

The drilling rig 10 functions to drill the wellbore 32. The drilling rig 10 may include the drilling control system 12 in accordance with the present disclosure. The drilling control system 12 may coordinate with certain aspects of the drilling rig 10 to perform certain drilling techniques. For example, the drilling control system 12 may control and coordinate rotation of the drill string 30 via the top drive 42 and supply of drilling mud to the wellbore 32 via a pumping system 52. The pumping system 52 may include a pump or pumps 54 and conduit or tubing 56. The pumps 54 may be configured to pump drilling fluid downhole via the tubing 56, which may communicatively couple the pumps 52 to the wellbore 32. In the illustrated embodiment, the pumps 54 and tubing 56 are configured to deliver drilling mud to the wellbore 32 via the top drive 42. Specifically, the pumps 54 may deliver the drilling mud to the top drive 42 via the tubing 56, the top drive 42 may deliver the drilling mud into the drill string 30 via a passage through the quill 44, and the drill string 30 may deliver the drilling mud to the wellbore 32 when engaged in the wellbore 32. The drilling control system 12 may manipulate aspects of this process to facilitate performance of specific drilling strategies in accordance with present embodiments. For example, as will be discussed below, the drilling control system 12 may control rotation of the drill string 30 by controlling operational characteristics of the top drive 42 based on inputs received from sensors and/or manual input.

In the illustrated embodiment, the top drive 42 is utilized to transfer rotary motion to the drill string 30 via the quill 44, as indicated by arrow 58. In other embodiments, different drive systems (e.g., a rotary table, coiled tubing system,) may be utilized to rotate the drill string 30 (or vibrate the drill string 30). Where appropriate, such drive systems may be used in place of the top drive 42. It should be noted that the illustration of FIG. 1 is intentionally simplified to focus on particular features of the drilling rig 10. Many other components and tools may be employed during the various periods of formation and preparation of the well. Similarly, as will be appreciated by those skilled in the art, the orientation and environment of the well may vary widely depending upon the location and situation of the formations of interest. For example, the well, in practice, may include one or more deviations, including angled and horizontal runs. Similarly, while shown as a surface (land-based) operation, the well may be formed in water of various depths, in which case the topside equipment may include an anchored or floating platform.

In the illustrated embodiment, the drill string 30 includes a bottom-hole assembly (BHA) 60 coupled to the bottom of the drill string 30. The BHA 60 may include a drill bit 62 that may be configured for drilling the downhole end of the wellbore 32. Straight line drilling may be achieved by rotating the drill string 30 during drilling. In another embodiment, the drill bit 62 may include a bent axis motor-bit assembly or the like that is configured to guide the drill string 30 in a particular direction for directional drilling. The BHA 60 may include one or more downhole tools (e.g., a measurement-while-drilling (MWD) tool, a logging-while-drilling (LWD) tool) that may be configured to provide data (e.g., via pressure pulse encoding through drilling fluid, acoustic encoding through drill pipe, electromagnetic transmissions) to the drilling control system 12. For example, the MWD tool and the LWD tool may obtain data including orientation of the drill bit 62, location of the BHA 60 within the wellbore 32, pressure and temperature within the wellbore 32, rotational information, mud pressure, tool face orientation, vibrations, torque, linear speed, rotational speed, and the like.

As will be discussed below, the top drive 42 and, consequently, the drill string 30 may be rotated based on instructions from the drilling control system 12, which may include automation and control features and algorithms for addressing torsional vibrations, such as stick-slip. As illustrated, a sensor 70 may be coupled to the top drive 42 and configured to measure one or more parameters of the top drive 42 and to communicate the measured data to the drilling control system 12. For example, the sensor 70 may measure parameters such as a hydraulic pressure across supply and return lines of a hydraulic top drive, torque, rotary speed, amplitude of torsional vibrations, and/or frequency of torsional vibrations. As will be discussed in greater detail below, based on the measured data from the sensor 70 and/or the downhole tools, the drilling control system 12 may control the rotation of the top drive 42 based on an energy method model and the measured torque of the drill string 30 to mitigate or reduce the torsional vibrations along the drill string 30. Additionally, the drilling control system 12 may calculate a suggested weight-on-bit (WOB) value to mitigate or avoid reappearance of the torsional vibrations and/or to increase a rate of penetration once smooth drilling has been achieved. The drilling control system 12 may include one or more automation controllers with one or more processors and memories that cooperate to store received data and implement programmed functionality based on the data and algorithms. The drilling control system 12 may communicate (e.g., via wireless communications, via dedicated wiring, or via other communication systems) with various features of the drilling rig 10, including, but not limited to, the top drive 42, the pumping system 52, the drawworks 28, an auto driller, and downhole features (e.g., the BHA 60).

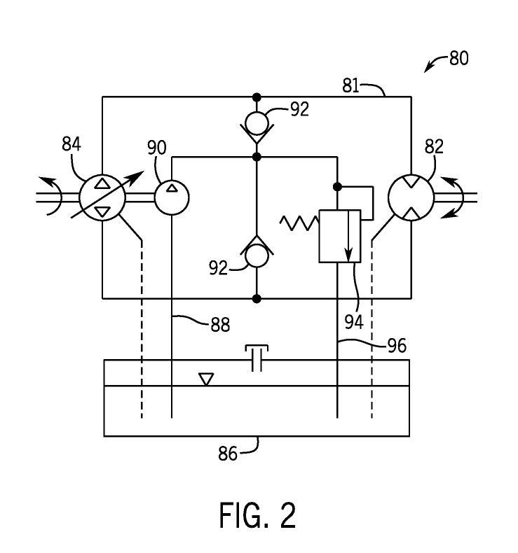

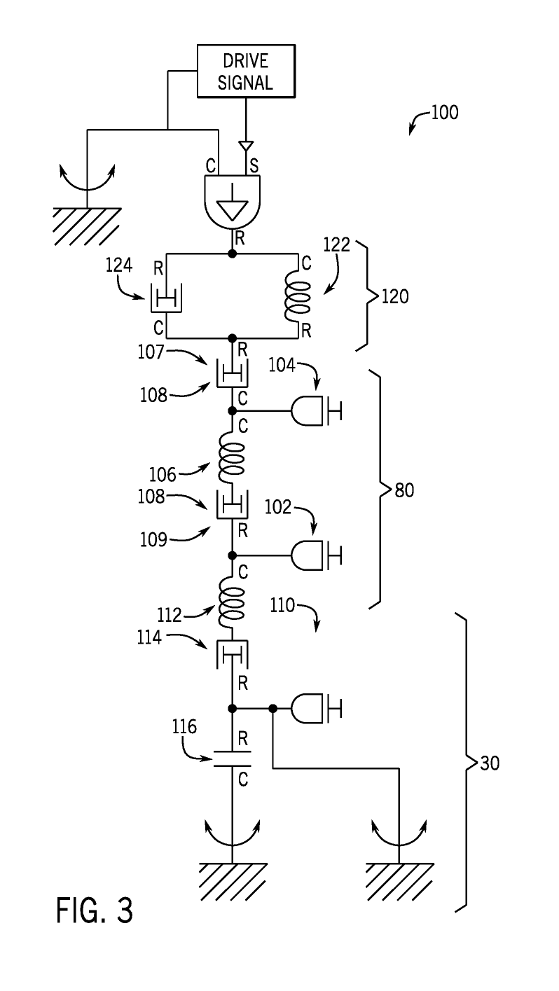

FIG. 2 illustrates a schematic diagram of an embodiment of a closed-loop hydraulic circuit 81 of a hydraulic top drive 80 that may be employed on the drilling rig 10. As previously discussed, the top drive 42 of the drilling rig 10 may be used to provide rotary motion 58 and torque to the drill string 30 to drill the borehole. The top drive 42 may also be utilized to disconnect and remove sections of the tubular 40 from the drill string 30. The top drive 42 may be the hydraulic top drive 80, however, it should be understood that the present embodiments are also applicable to electric top drives. In some embodiments, the hydraulic top drive 80 may include a series of parallel hydraulic motors 82 connected to a series of parallel pumps 84 (e.g. axial position pumps) through circuits 81. In the illustrated embodiment, there is one pump 84 coupled to one motor 82 via the circuit 81. However, here may be any number (e.g. 1, 2, 3, 4, 5, or more) of hydraulic motors 82 and/or pumps 84, and therefore any number of circuits 81 in the hydraulic top drive 80. The pumps 84 may be coupled to a reservoir 86 that may be filled with a hydraulic fluid, such as oil, via a supply line 88. The pumps 84 may pump the hydraulic fluid from the reservoir 86 into the circuit 81 of the hydraulic top drive 80. There may be a charge pump 90 located near the pump 84. The charge pump 90 may be disposed along the supply line 88 and may be used to ensure the circuit 81 stays filled with hydraulic fluid, as some hydraulic fluid may be lost through the pump 84 and the motor 82. The charge pump 90 may be connected to the closed-loop of the circuit 81 of the hydraulic top drive 80 through one or more check valves 92. The check valves 92 may be one way valves used to ensure that the hydraulic fluid from the charge pump 90 may only flow from the charge pump 90 into the circuit 81 of the hydraulic top drive 80. The circuit 81 of the hydraulic top drive 80 may also include a relief valve 94. The relief valve 94 may limit the pressure (e.g., charge pressure) within the circuit 81 of the hydraulic top drive 80 to a particular level. To do so, the relief valve 94 may bleed off some of the hydraulic fluid from the circuit 81 into the reservoir 86 via a return line 96. The circuit 81 may be formed from flexible hoses, however the circuit 81 may also be formed from pipes and/or tubes. The circuit 81 may be filled with pressurized hydraulic fluid, which may travel through the motor 82. The motor 82 creates the rotary motion 58 provided by the hydraulic top drive 80. The energies of the components of the hydraulic top drive 80 may be used to design the controller of the drilling control system 12, as discussed in greater detail with reference to FIGS. 3-5.

FIG. 3 is a schematic diagram of an embodiment of a mechanical representation or model 100 of the hydraulic top drive 80 of FIG. 2 and the drill string 30. The mechanical model 100 of the hydraulic top drive 80 may be used to illustrate the energies of one or more component of the hydraulic top drive 80 and the drill string 30 attached. The energies of the components of the hydraulic top drive 80 and the drill string 30 may be used to determine the desired parameters of the speed controller for the top drive 42 to mitigate drill string 30 torsional vibrations. The energies of the components of the hydraulic top drive 80 and the drill string 30 may each fall into one of three categories: kinetic energy, potential energy, or dissipative energy. Kinetic energy is energy that a component may possess by virtue of being in motion. Energies of the system that may fall into the category of kinetic energy may include a pump inertia, a motor inertia, a BHA inertia, and a drill string inertia. Potential energy is stored energy and may be represented by a spring in the mechanical model 100. Energies of the system that may fall into the category of potential energy may include elasticity of the flexible hoses of the hydraulic circuit 81 and stiffness of the drill string 30. Dissipative energy describes a loss of energy in the system. Energies of the system that may fall into the category of dissipative energy may include downhole friction, viscous dampening, and top drive leakage from the pump 84 and/or the motor 82 of the hydraulic top drive 80.

In the mechanical model 100, the hydraulic top drive 80 may include at least two inertias, and therefore two kinetic energies. The hydraulic top drive 80 may include a motor inertia 102 that represents the equivalent rotational inertia of the hydraulic motors 82, gearbox, and quill. The hydraulic top drive 80 may also include a pump inertia 104 that represents the equivalent rotational inertias of the pumps 84. Further, the hydraulic top drive 80 may include at least one potential energy 106 and at least one dissipative energy 108. The potential energy 106 of the hydraulic top drive 80 may include the compressibility of the hydraulic fluid within the circuit 81 and the elasticity of the flexible hoses that make up the circuit 81, and may be represented as a spring in the mechanical model 100. The dissipative energy 108 of the hydraulic top drive 80 may include a damper 107 representing leakage of the hydraulic fluid from the motor 82 and/or the pump 84 and overall losses of hydraulic fluid in the circuit 81. The dissipative energy 108 may further include a damper 109 representing mass of the hydraulic fluid traveling between the motor 82 and pump 84.

In the mechanical model 100, the drill string 30 may also include kinetic, potential, and dissipative energies. The drill string 30 may include at least one inertia, and therefore one kinetic energy, such as a BHA inertia 110. The BHA inertia 110 may represent the rotational inertia of the BHA 60. The drill string 30 may include at least one potential energy 112 that may represent the stiffness of the drill string 30, and may be represented in the mechanical model 100 as a spring. Further, the drill string 30 may include at least two dissipative energies. The drill string 30 may be subject to a linear damping 114 representing viscous damping that may be caused by fluid within the wellbore 32, such as drilling mud. Linear damping is friction or resistance that may slow down an object moving in any direction, while rotational damping (e.g., angular damping) is friction or resistance that may slow down an object that is rotating or spinning. The drill string 30 may also be subject to a non-linear damping 116 representing downhole friction that may be caused by the drill bit 62 and/or drill string 30 contacting the edges of the formation into which the wellbore 32 is being drilled and/or the wellbore 32.

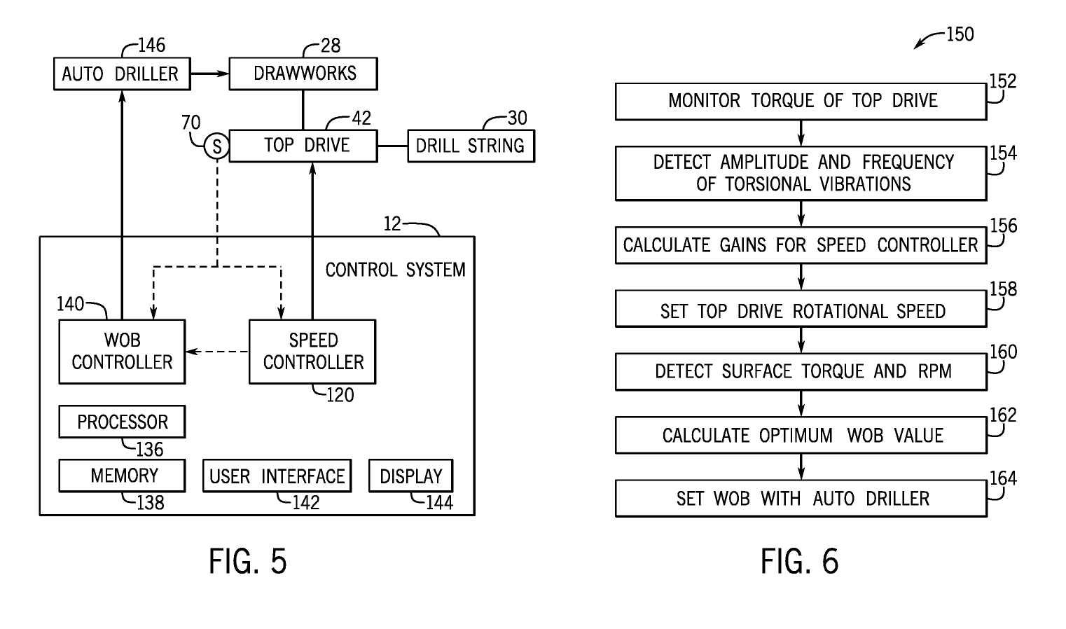

The mechanical model 100 may further include parameters that may be implemented in a speed controller 120 (e.g., PI controller) of the drilling control system 12. The drilling control system 12 may be implemented as the speed controller 120 to control the rotational speed of the hydraulic top drive 80. In some embodiments, the drilling control system 12 may be implemented as a high pass filter. The speed controller 120 may include adjustable parameters relating to proportional gains, Kₚ, 122 and integral gains, K_{I}, 124. These parameters may be calculated using an energy method reduce or minimize the energies of the components of the hydraulic top drive 80 and the drill string 30 to mitigate drill string torsional vibrations, as discussed in greater detail with reference to FIG. 5.

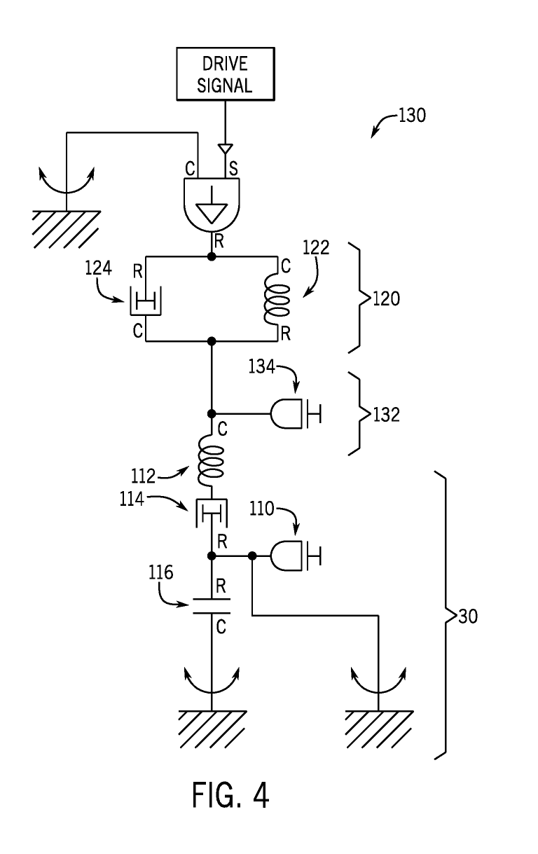

Similarly, FIG. 4 is a schematic diagram of an embodiment of a mechanical model 130 that represents an electric top drive 132 that may be employed in the drilling rig 10 and the drill string 30. As previously discussed, the present embodiments are discussed within the context of hydraulic top drives, however they are also applicable to electric top drives. The model of the mechanical model 130 of the electric top drive 132 may be used to illustrate the energies of one or more components of the electric top drive 132 and the drill string 30 attached thereto. The mechanical model 130 of an electric top drive 132 may be simplified compared to the mechanical model 100 of the hydraulic top drive 80. The mechanical model 130 of the electric top drive 132 may include one inertia, an AC motor inertia 134, that may represent inertia of the AC motor, gearbox, and quill, and may not include the potential energy of the supply and return lines or the dampening of leakage from the pump 34, as shown in the mechanical model 100 of the hydraulic top drive 80 of FIG. 3.

As in the mechanical model 100, in the mechanical model 130, the drill string 30 may also include kinetic, potential, and dissipative energies. The drill string 30 may include at least one inertia, and therefore one kinetic energy, such as BHA inertia 110. The BHA inertia 110 may represent the rotational inertia of the BHA 60. The drill string 30 may include at least one potential energy 112 that may represent the stiffness of the drill string 30, and may be represented in the mechanical model 130 as a spring. Further, the drill string 30 may include at least two dissipative energies. The drill string 30 in the illustrated embodiment may be subject to the linear damping 114 representing viscous damping that may be caused by fluid within the wellbore 32, such as drilling mud. Linear damping is friction or resistance that may slow down an object moving in any direction, while rotational damping (e.g., angular damping) is friction or resistance that may slow down an object that is rotating or spinning. The drill string 30 in the illustrated embodiment may also be subject to the non-linear damping 116 representing downhole friction that may be caused by the drill bit 62 contacting the edges of the formation into which the wellbore 32 is being drilled.

The mechanical model 130 may further include energies or parameters that may be implemented in the speed controller 120 (e.g., PI controller) of the drilling control system 12. The drilling control system 12 may be implemented as the speed controller 120 to control the speed of the hydraulic top drive 80. The speed controller 120 may include adjustable parameters relating to proportional gains, Kₚ, 122 and integral gains, K_{I}, 124. These parameters may be calculated using an energy method to reduce or minimize the energies of the components of the electric top drive 132 and the drill string 30 to mitigate drill string torsional vibrations, as discussed in greater detail with reference to FIG. 5.

FIG. 5 illustrates schematically the drilling control system 12 in accordance with the present disclosure. As discussed above, the drilling control system 12 may control the rotational speed of the top drive 42 to rotate the drill string 30 for drilling the wellbore 32. The drilling control system 12 may include a distributed control system (DCS), a programmable logic controller (PLC), or any computer-based automation controller or set of automation controllers that is fully or partially automated. For example, the drilling control system 12 may be any device employing a general purpose or an application-specific processor 136. In the illustrated embodiment, the drilling control system 12 is separate from the top drive 42. It should be noted that, in some embodiments, aspects of the drilling control system 12 may be integrated with the top drive 42 or other features (e.g., the BHA 60).

The drilling control system 12 may include the processor 136 and a memory 138 for storing instructions executable by a speed controller 120 and a weight-on-bit (WOB) controller 140 to perform methods and control actions described herein for the top drive 42. The memory 138 may include one or more tangible, non-transitory, machine-readable media. By way of example, such machine-readable media can include RAM, ROM, EPROM, EEPROM, CD-ROM, or other optical disk storage, magnetic disk storage or other magnetic storage devices, or any other medium which can be used to carry or store desired program code in the form of machine-executable instructions or data structures and which can be accessed by the processor 136 or by any general purpose or special purpose computer or other machine with a processor.

The drilling control system 12 may also include other components, such as a user interface 142 and a display 144. Via the user interface 142, an operator may provide commands and operational parameters to the drilling control system 12 to control various aspects of the operation of the drilling rig 10. The user interface 144 may include a mouse, a keyboard, a touch screen, a writing pad, or any other suitable input and/or output devices. The commands may include start and stop of the top drive 42, detection and calculation of the frequency of the torsional vibrations of the drill string 30, such as a comparison of the detection frequency with the theoretical frequency, engagement and disengagement of torsional vibration mitigation function (e.g., provided by the speed controller 120 and the WOB controller 140), and so forth. The operational parameters may include temperature and pressure of the BHA 60, the number of drill pipe segments or drill collar segments in the drill string 30, the length, inner diameter, and outer diameter of each drill pipe segment or drill collar segment, and so forth. The display 144 may be configured to display any suitable information of the drilling rig 10, such as the various operational parameters of the drilling rig 10, the torque data of the drill string 30, the rotary speed of the top drive 42, and so forth.

The drilling control system 12 may be implemented as and may include the speed controller 120 for controlling the rotation speed of the top drive 42 to mitigate or reduce the torsional vibrations (e.g., stick-slip oscillations) of the drill string 30. If the speed of the top drive 42 is not readily available, the speed controller 120 may control a stroke length of the one or more pumps 84 within the hydraulic top drive 80. Control of the speed of the top drive 42 may utilize an energy method to reduce or minimize the energies of the components of the hydraulic top drive 80 and the drill string 30. For this, the principle of Lagrange's equations, which states the balance between kinetic, potential, and dissipative energies, may be used. The Hamiltonian principle, which turns into the Lagrange's equation for a finite dimensional system, may also be used. The LaGrangian system may be represented as: L=T−V, where T is the kinetic energies of the system and V is the potential energies of the system. The characteristic equation of the system (e.g. the hydraulic top drive 80 and the drill string 30) may be obtained based on Lagrange's equation as:

$$\frac{d}{dt} ( \frac{\partial L}{\partial \dot{x}} ) - \frac{\partial L}{\partial x} + \frac{\partial P}{\partial \dot{x}} = 0 \qquad ( 1 )$$

where P is the dissipative energies in the system. The hydraulic top drive system 80 includes three inertias, i.e., the motor inertia 102, the pump inertia 104, and the BHA inertia 110 of the drill string 30. Therefore, the general coordinates for Equation 1 may be (x₁, x₂, x₃). With all of the energies of the system input into Equation 1, Equation 1 results in a 6-order characteristic equation that describes the system. The goal of the design of the speed controller 120 is to find the proportional and integral gains, Kₚ and K_{I} respectively, such that the 6 roots of this characteristic equation are exponentially decaying to zero. That is, to find the desired proportional and integral gains such that the roots of this characteristic equation exhibit the fastest possible decay.

To this end, in some embodiments, the proportional and integral gains, Kₚ 122 and K_{I} 124, may be derived out of the original 6-order equation. The energies of the drill string 30 (e.g., stiffness, mass, and damping) can be derived by adjusting the theoretical estimated value after performing Fast Fourier Transform (FFT). That is, the frequency and amplitude from the FFT may be used to improve the theoretical estimation. The energies of the pump and the motor (mass and damping) may be found by the combination of the constant speed and cruise-to-stop tests. The Kₚ 122 and K_{I} 124, the proportional and integral gains, may be obtained based on the improved algorithm such that the system is sufficiently damped.

In some embodiments, the design may be carried to a reduced-order equation (e.g., second-order equation) by neglecting the top drive values of the motor inertia 102 (e.g., the equivalent rotational inertia of the hydraulic motors and gearbox), the pump inertia 104 (e.g., the equivalent rotational inertia of the pumps), and the dissipative energy 108 representing the leakage of hydraulic oil and overall losses in the circuit. Further, to carry the design to the reduced-order equation, in some embodiments, the potential energy 106 (e.g. elasticity of the flexible hoses) may be set as equal to one in the control design. Thus, the Kₚ 122 and K_{I} 124, the proportional and integral gains, for the reduced-order system that describes the downhole behavior may be derived.

To fit the reduced-order model to the downhole system, Fast Fourier Transform (FFT) may be utilized. An amplitude and frequency of the torsional vibrations may be detected by sensor 70 or any other suitable sensor, or may be indirectly measured and calculated based on the vibration measured in pressure, speed, or torque. The detected amplitude and frequency of the torsional vibrations may be used to fit the reduced-order characteristic equation to the downhole system, assuming the vibrations are due to the dynamics of the drill string 30. The calculated proportional and integral gains, Kₚ 122 and K_{I} 124, from the reduced-order equation may be confirmed in the 6-order original Equation 1 to verify that the speed controller 120 dampens all or substantially all of the roots of the original system. That is, the response of the original system, Equation 1, exponentially decays to zero, thus verifying that the speed controller 120 may provide enough dampening to mitigate the torsional vibrations (e.g. slip-stick vibrations) of the drill string 30.

Additionally, in some embodiments, the drilling control system 12 may include the weight-on-bit (WOB) controller 140. The WOB controller 140 may generate a suggested WOB value for an auto driller 140 to help avoid or mitigate reappearance of torsional vibrations once the speed controller 120 has restored smooth drilling and to increase the rate of penetration (ROP) to an optimum value. Increasing the WOB once the Kₚ 122 and the K_{I} 124 values have been calculated by the speed controller 120, in the manner previously discussed, may increase the ROP at that time. However, the relationship between the WOB and the ROP may not always be linear, and it may vary based on the type of drill bit 62 used and characteristics of the formation into which the wellbore 32 is being drilled.

The interaction between the drill bit 62 and the mineral formation may be characterized by a coefficient of friction (e.g. bit aggressiveness). The bit aggressiveness for different types of bits, such as polycrystalline compact bits or diamond impregnated matrix bits, may be obtained from a manufacturer or from other sources. Bit aggressiveness is defined as the slope of the torque-on-bit (TOB) versus the WOB curve. Assuming a constant coefficient of friction at the interface between the drill bit 62 and the mineral formation, it may be possible to derive the relationship between the WOB and the TOB in an analytical method. With a manipulation method, the WOB may be derived for a given TOB and bit aggressiveness. In some embodiments, a direct measurement of TOB may be available through a torque-on-bit sensor. In some embodiments, if direct measurement of the TOB is not available for the drilling rig 10, the WOB controller 140 may estimate the TOB as a function of surface torque and revolutions per minute (RPM). Measurements of surface torque and RPM may be obtained through sensor 70 or any other suitable source. The WOB controller may then calculate the optimum value of WOB for the type of drill bit 62 and mineral formation to increase the ROP of the drill bit 62 and help reduce reappearance of the torsional vibrations mitigated by the speed controller 120. The WOB controller 140 may send the optimum WOB calculated to the auto driller 146. The auto driller 146 may send a signal to the drawworks 28 indicative of the suggested WOB calculated to increase the ROP while reducing reappearance of the torsional vibrations.

FIG. 6 illustrates a method 150 for mitigating the torsional vibrations (e.g., stick-slip oscillations) of the drilling rig 10 and increasing ROP in accordance with the techniques described above. It should be noted that the method 150 may be implemented by the drilling control system 12 either separate from or integrated with existing control schemes for the top drive 42. As noted above, the top drive 42 (e.g., hydraulic top drive 80) delivers an output torque (e.g., via the quill 44) to rotate the drill string 30 for drilling the wellbore 32. The torque of the top drive 42 may be monitored (block 152) (e.g. via the sensor 70) during drilling (e.g., in real time). As previously discussed, the sensor 70 may also detect the amplitude and frequency of the torsional vibrations (e.g., stick-slip) (block 154). The speed controller 120 of the drilling control system may utilize the 6-order equation derived from Lagrange's equation (Equation 1 above) to further derive the proportional and integral gains, Kₚ 122 and K_{I} 124, for the speed controller 120. In some embodiments, the 6-order characteristic equation may be reduced to a reduced-order equation (e.g., second-order equation) by neglecting the top drive values of the motor inertia 102, the pump inertia 104, and the dissipative energy 108 representing the leakage of hydraulic oil and overall losses in the circuit, and, in some embodiments, setting the potential energy 106 (e.g., elasticity of the hoses) equal to one. The detected amplitude and frequency values of the torsional vibrations may be used to fit the reduced-order characteristic equation to the downhole system. The proportional and integral gains, Kₚ 122 and K_{I} 124, may be calculated from the reduced-order equation (block 156) and may be confirmed in the 6-order original to verify that the speed controller 120 will provide sufficient damping to the 6-order equation and/or the reduced-order equation to mitigate the torsional vibrations. With the proportional and integral gains of the speed controller 120 calculated, the speed controller 120 may set the proportional and integral gains and thus, the rotational speed of the top drive 42 (block 158).

In the case of a high pass filter, the parameters calculated from the 6-order or reduced order equation may be a gain and a cutoff frequency of the high pass filter. The high pass filter set with the calculated parameters may be use the measured torque to adjust the speed of the rotation. In some embodiments, the speed controller 120 may be treated as a spring-damper. In such an approach, the values of the spring and damper (e.g., Kₚ 122 and K_{I} 124) may be found so that the overall system behaves as a tuned damped system.

As previously discussed, once the proportional and integral gains of the speed controller 120 have been calculated and set, and the rotational speed of the top drive 42 has been set, the WOB controller 140 may determine and set a suggested WOB that may increase the ROP and reduce the reappearance of the torsional vibrations mitigated by the speed controller 120. The sensor 70 may detect the surface torque and RPM of the drill bit 62 (block 160). The WOB controller 140 may calculate the suggested WOB value based on the detected surface torque, RPM, and the coefficient of friction (e.g., bit aggressiveness) of the drill bit 62 that may be obtained from the manufacturer (block 162). The WOB controller 140 may calculate the suggested WOB value that may increase the ROP and reduce the reappearance of the torsional vibrations in the drill string 30. The WOB controller 140 may send a signal to the auto driller 146 indicative of the suggested WOB, and the auto driller 146 may set the WOB using the drawworks 28 (block 164). The calculation of the proportional and integral gains of the speed controller 120 using the energy method and the calculation of the suggested WOB value subsequent to setting the rotational speed of the top drive 42 with the speed controller 120 may enable a mitigation in the torsional vibrations in the drill string 30, an increase in the ROP, and a reduction in the reappearance of the torsional vibrations (e.g., stick-slip).

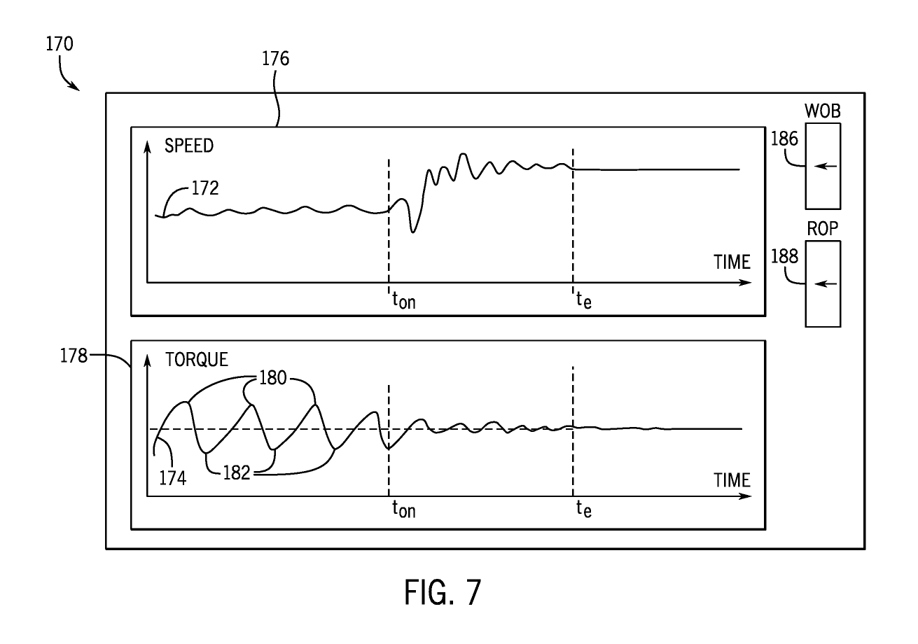

FIG. 7 illustrates a user interface 170 for displaying a speed profile 172 and a torque profile 174 for the top drive 42. More specifically, a box 176 illustrates the speed of the top drive 42 as a function of time, and a box 181 illustrates the torque of the top drive 42 as a function of time. The speed and torque profiles 172, 174 may be collected in real time (e.g., when the drilling rig 10 is in operation). The speed and torque may be measured by any suitable sensors, including speed sensors and torques sensors, coupled to the top drive 42, such as sensor 70. In some embodiments, the torque may be measured indirectly, for example, by measuring inlet and outlet pressures of the supply and return lines of the top drive 42. The speed and torque profiles 172, 174 may be obtain by collecting individual data points at any suitable time intervals (e.g., 0.001 seconds, 0.002 seconds, 0.003 seconds, 0.004 seconds, 0.005 seconds, 0.01 seconds, 0.02 seconds, 0.05 seconds, 0.1 seconds, 0.2 seconds, 0.5 seconds, 1 second, or more). At a time tₒₙ, the torsional vibration mitigation, according to the techniques discussed in detail above, may be engaged or turned on by the drilling control system 12. As illustrated, before the time tₒₙ, the torque profile 174 of the top drive 42 may include an oscillation pattern (e.g., the torque oscillation) with a series of alternating peaks 180 and troughs 182.

Further, the user interface 170 that may be used to display the status of the torsional vibrations (e.g., stick-slip) upon implementation of the torsional vibration mitigation techniques, as discussed in detail above. More specifically, the stick-slip oscillations may be observed on the fluctuations of the surface torque (e.g., the torque profile 174 before the time tₒₙ). After the torsional vibration mitigation is engaged at the time tₒₙ, the oscillations on the torque profile 174 vanish gradually or decreased substantially. After the torsional vibration mitigation is engaged at the time tₒₙ, the speed may become increasingly oscillated due to the adjustment of the rotational speed for the top drive 42 by the speed controller 120 of the controller system 12. The oscillation of the rotational speed also gradually vanishes or decreases substantially and becomes substantially a constant value. Accordingly, the downhole rotation (e.g., at the BHA) becomes more smooth. For example, at a time tₑ, the torque of the top drive 42 has substantially a constant value. Further, the user interface 170 may also include boxes for displaying the WOB and ROP. For example, the user interface 190 may include a box 186 for displaying the WOB and a box 188 for displaying the ROP, both of which may be controlled by the WOB controller 130 of the drilling control system 12.

The present embodiments address issues related to torsional vibrations (e.g., stick-slip). The torsional vibration mitigation system according to the present embodiments utilizes a combination of an energy method to consider the complexity of the top drive and downhole model and a FFT analysis to fit the model to the downhole dynamics. Further, the energy method may enable the drilling control system to take into account downhole elements, such as linear viscous damping and nonlinear friction into the design. Use of the FFT analysis of the torque signal enable the model to be fit to the downhole dynamics, thus increasing accuracy of the final calculations. Further in some embodiments, the torsional vibration mitigation system includes a suggested WOB calculation to help reduce reappearance of torsional vibrations and increase the ROP once mitigation. The present embodiments also include user interfaces for automatically monitoring, calculating, and displaying, parameters for the torsional vibration mitigation system.

While only certain features of the present disclosure have been illustrated and described herein, many modifications and changes will occur to those skilled in the art. It is, therefore, to be understood that the appended claims are intended to cover all such modifications and changes as fall within the true spirit of the disclosure.

1. A method of rotating a drill string driven by a drive system using a control system implemented by a controller or a filter, comprising:
generating a mathematical energy model of the drive system, the drill string, and the controller, wherein the mathematical energy model comprises at least one or more first energy values of the drive system and one or more second energy values of the drill string;
determining the one or more first energy values of the drive system and the one or more second energy values of the drill string;
measuring one or more vibration values of torsional vibrations at the drive system with a sensor;
determining an updated proportional gain and an updated integral gain of the controller or the filter based on at least the one or more first energy values of the drive system, the one or more second energy values of the drill string, and the one or more vibration values;
providing an output signal representing the updated proportional gain and the updated integral gain to the controller or the filter; and
controlling rotation of a quill of the drive system based on the output signal.

2. The method of claim 1, wherein determining the updated proportional gain and the updated integral gain comprises:
entering the one or more first energy values of the drive system and the one or more second energy values of the drill string into the mathematical energy model;
reducing the order of the energy model to create a reduced order energy model;
fitting the reduced order energy model to dynamics of the drill string using a Fourier Transform; and
deriving the updated proportional gain and the updated integral gain of the controller or the filter.

3. The method of claim 1, wherein the one or more first energy values of the drive system and the one or more second energy values of the drill string comprise kinetic energy values, potential energy values, or dissipative energy values.

4. The method of claim 3, wherein the one or more first energy values of the drive system comprises kinetic energy values of the drive system, and the kinetic energy values of the drive system comprise a motor inertia value and a pump inertia value.

5. The method of claim 2, wherein reducing the order of the energy model comprises neglecting one or more of the one or more first energy values of the drive system.

6. The method of claim 1, wherein the drive system comprises a hydraulic drive system.

7. The method of claim 1, wherein the one or more vibration values comprises an amplitude value and a frequency value of the torsional vibrations.

8. The method of claim 1, comprising:
determining a torque value of the drive system;
calculating a suggested weight-on-bit value based on at least the instantaneous rotational speed of the drive system, the torque value, and a coefficient of friction of the drill bit; and
providing an output signal representing the suggested weight-on-bit value.

9. A system for rotating a drill string, comprising:
a drive system configured to rotate the drill string at variable rotational speeds based on control signals received by the drive system; and
a control system configured to transmit the control signals to the drive system, wherein the control system is configured to generate the control signals based on at least a mathematical energy model of the drive system, the drill string, and the control system, and one or more vibration values of torsional vibrations at the drive system, wherein the mathematical energy model comprises at least one or more energy values of the drive system.

10. The system of claim 9, wherein the drive system comprises a hydraulic top drive configured to rotate the drill string based on the control signals.

11. The system of claim 9, comprising a sensor coupled to the drive system and configured to measure the one or more vibration values.

12. The system of claim 9, wherein the one or more vibration values comprises an amplitude value and a frequency value of the torsional vibrations.

13. The system of claim 9, wherein the control system is configured to determine an instantaneous speed of the drive system based on at least the mathematical energy model of the drive system and the drill string, wherein the control signals represent the instantaneous speed of the drive system.

14. The system of claim 9, wherein the control system is configured to fit the energy model to dynamics of the drill string using a Fourier Transform and configured to neglect at least one energy value of the one or more energy values of the drive system.

15. The system of claim 9, wherein the control system comprises a PI controller or a filter, wherein the PI controller or the filter is configured to update a proportional gain and an integral gain based on at least the one or more energy values of the drive system, the one or more vibration values, and one or more second energy values of the drill string.

16. The system of claim 9, wherein the control system comprises a weight-on-bit controller, wherein the weight-on bit controller is configured to determine a suggested weight-on-bit value based on at least the instantaneous speed of the drive system, a torque value of the drive system, and a coefficient of friction of a drill bit of the drill string.

17. A control system, comprising:
an automation controller comprising a processor and a memory configured to supply a drive system for rotating a drill string with control signals based on a mathematical energy model of at least the drive system and the drill string, and one or more vibration values of torsional vibrations at the drive system, wherein the mathematical energy model comprises at least one or more first energy values of the drive system and one or more second energy values of the drill string; and
a display interface configured to display at least the one or more vibration values of the torsional vibrations and a torque value of the drive system.

18. The control system of claim 17, wherein the automation controller comprises a PI controller or a high pass filter configured to update a proportional gain and an integral gain based on at least the one or more first energy values of the drive system and the one or more second energy values of the drill string.

19. The control system of claim 18, wherein the PI controller or the high pass filter is configured to update the proportional gain and the integral gain by fitting the mathematical energy model to dynamics of the drill string using a Fourier Transform and neglecting at least one value of the one or more first energy values of the drive system.

20. The control system of claim 17, wherein the automation controller comprises a weight-on-bit controller configured to determine a suggested weight-on-bit value based on at least the torque value and a coefficient of friction of a drill bit of the drill string.
